(19) United States
(12) Patent Application Publication
(10) Pub. No.: US 2007/0265902 A1
(43) Pub. Date: Nov. 15, 2007

(54) Event coordination and evaluation system including compliance monitoring

(76) Inventors: Danamichele Brennen, Philadelphia, PA (US); Jim Sivori, New York, NY (US); Gregory Truitt, Long Branch, NJ (US); Eric Broadway, Lawrenceville, NJ (US); Paul R. Tyndall, Wilmington, NC (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/650,242

(22) Filed: Jan. 5, 2007

Related U.S. Application Data
(60) Provisional application No. 60/757,200, filed on Jan. 6, 2006.

(51) Int. Cl. G06F 9/46

(52) U.S. Cl. 705/8

(57) ABSTRACT

Provided is a method and system for using a computer for event management and ensuring compliance with rules pertaining to events. The rules can include laws, regulations, and policies, and can be stored in a database for use by the system. A user interface is used for specifying event information such as event date and time, agenda, invitees, speakers, venue, A/V equipment, etc. The system can generate reports about the event, track and reconcile event costs, verify attendance, and monitor event parameters to ensure compliance with the rules. Also provided is a method and system for using a computer for historical event evaluation, and for generating recommendations for future events.

### CROSS REFERENCE TO RELATED APPLICATIONS

Reference is made to and priority claimed from U.S. Provisional Application No. 60/757,200, filed Jan. 6, 2006, which is incorporated herein by reference.

### BACKGROUND

Hosting or sponsoring events is an important activity in many organizations. For example, meetings are regularly conducted in many organizations for management, shareholder, and/or customer purposes. In some industries for example, meetings are frequently conducted to disseminate information, such as information regarding new products or services, or other information that may impact their customers or other stakeholders.

In certain organizations and even entire industries, such as the pharmaceutical industry, such events are commonplace. For example, it is frequently the case that a pharmaceutical company will invite a group of medical professionals to an event in order to present information on a topic of interest. Such events can include simple luncheons or dinner meetings, or they can involve more complex agendas such as extended multi-day programs covering many topics, or a single large event where a multi-topic program can be presented.

The planning and logistical set-up for many events, even small events, can be extensive, and the logistical issues for setting up longer, larger, and more complex events can be correspondingly more extensive. In recent years, event planning companies have come into existence that specialize in event planning for various industries. For example, such an event planning company can be retained by a pharmaceutical company to organize a marketing event that includes a dinner for a group of physicians, at which a trained and authorized speaker can present information about a new drug. The event planning company would take care of planning, setting up and executing the logistical aspects of the event, such as choosing or arranging a venue, determining the dinner menu, sending invitations to the sales representatives who are responsible for the meeting, identifying and inviting guests, arranging transportation for the guests and/or the presenter if necessary, supporting the event, reconciling the event costs, advising on event strategy, etc. Advising on event strategy can include the use of data to make decisions on whether or not to hold an event, in addition to how to manage an event.

While using event planning companies has provided a means for many companies to facilitate the logistical set-up of hosting or sponsoring events, there are some drawbacks in the currently used methods. For example, the current methods of logistical planning, whether performed in-house or by an event planning company, require a large amount of manual effort. Venues are contacted by event planning personnel, speakers are communicated with by event planning personnel, invitations are physically mailed to invitees, costs are manually reconciled, etc. These manual efforts can contribute significantly to the cost of the event.

Additionally, management reports are often not generated regarding events, and when they are generated, they are often not sufficient to be of significant value to a manager responsible for the event and/or its associated costs, such as an executive of a pharmaceutical company. In addition, there may be policies of the organization, or government regulations, that govern certain event parameters, such as event cost and size, payments to presenters, benefits to attendees, etc. No efficient means is currently available for ensuring regulatory and policy compliance, and monitoring costs, attendance, speaker performance, etc. Such means can be of importance prospectively when planning an event, in addition to retrospectively after the event has concluded. Effective monitoring of event parameters has gained increasing importance as the number and complexity of rules and guidelines regulating many industries have increased, such as regulations regarding the monies that are spent on these events. For example, the pharmaceutical industry is subject to many government regulations regarding such monies, such as the compensation or other benefits that can be given to presenters and expenses that can be paid for presenters and/or event attendees. As such regulations become more prevalent and more complex, ensuring compliance has become an increasingly important and difficult task.

Thus, a need exists for a comprehensive event planning system that provides an efficient means of monitoring and controlling the costs, and coordinating the logistics, surrounding hosting or sponsoring events, such as marketing functions.

A need also exists to provide for efficient compliance assurance, such as assuring compliance with regulatory requirements such as governmental regulations and laws, and/or with company imposed rules and/or policies.

A need exists to monitor costs and compliance prospectively, such as when planning and budgeting for an event; in real time, such as when making arrangements for an event; and retrospectively, such as when reconciling the costs, assessing compliance, and evaluating the logistics surrounding an event.

In addition, a need exists for a system for performing an audit of event parameters, such as parameters regarding the costs, logistics, regulatory compliance, and policy compliance surrounding one or more events, regardless of whether or not the events were planned and/or executed by others; and for evaluating event parameters and making recommendations for improvement, such as regarding one or more currently planned events or prospective future events.

### SUMMARY

Provided are systems and methods for planning, coordinating, executing, reconciling, and/or evaluating an event, comprising coordinating event planning functions, generating reports indicative of event activities, reconciling event costs, and monitoring all activities prospectively and/or retrospectively, to assure compliance with a predetermined set of parameters.

In an exemplary embodiment, a system and method includes coordinating an event with a sponsor, providing program parameters, establishing a venue, selecting a presenter, selecting and inviting attendees, budgeting and reconciling event costs, and assuring that all aspects of the event are in compliance with a set of predetermined rules and/or policies.

### BRIEF DESCRIPTION OF THE DRAWINGS

For the purpose of illustrating the invention, there is shown in the drawings an exemplary implementation; however, it is understood that this invention is not limited to the precise arrangements and instrumentalities shown.

FIG. 1a is a diagram of an exemplary computing environment upon which an embodiment of the present invention can operate.

FIG. 1b is a diagram of a system in accordance with an exemplary embodiment of the present invention.

FIG. 2 is a flow chart illustrating a method of specifying an event in accordance with an exemplary embodiment of the present invention.

FIG. 3 is a flow chart illustrating a method of selecting invitees in accordance with an exemplary embodiment of the present invention.

FIG. 4 is a flow chart illustrating a method of selecting a speaker in accordance with an exemplary embodiment of the present invention.

FIG. 5 is a flow chart illustrating the back office processing steps performed in accordance with an exemplary embodiment of the present invention.

FIG. 6 is a flow chart illustrating a method of speaker confirmation in accordance with an exemplary embodiment of the present invention.

FIG. 7 is a flow chart illustrating a method of creating a request for a proposal to a venue or vendors in accordance with an exemplary embodiment of the present invention.

FIG. 8 is a flow chart illustrating a method of booking a venue or vendors in accordance with an exemplary embodiment of the present invention.

FIG. 9 is a flow chart illustrating a method of booking an audio visual vendor in accordance with an exemplary embodiment of the present invention

FIG. 10 is a flow chart illustrating a method of reconciliation in accordance with an exemplary embodiment of the present invention.

FIG. 11 is a flow chart illustrating a method of performing compliance monitoring in accordance with an exemplary embodiment of the present invention.

### DETAILED DESCRIPTION

### Illustrative Computing Environment

The term “event” is used herein to refer to a gathering of attendees of any kind which entails the use of any type of resource, such as a sales meeting, a management meeting, a wedding, a sporting event, or any other type of meeting or gathering.

The term “sponsor” is used herein to refer to a party, such as a person or a group of persons, who initiate the holding of an event, such as a sales representative or an event planner.

The term “user” is used herein to refer to a party who accesses the system, inputs information into the system, receives information from the system, or uses the method of the invention for any purpose related to the event, such as a sponsor, planner, invitee, presenter, vendor, administrator, manager, or compliance officer.

The term “rule” is used herein to refer to a law, regulation, policy, or guideline pertaining to an event or to the management of the event, and/or with which the event must be in compliance.

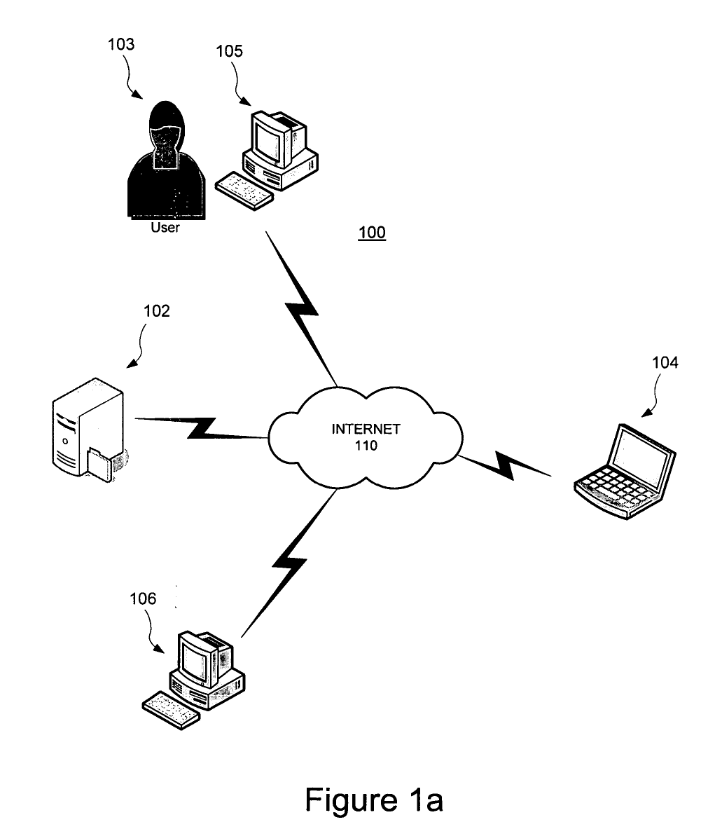

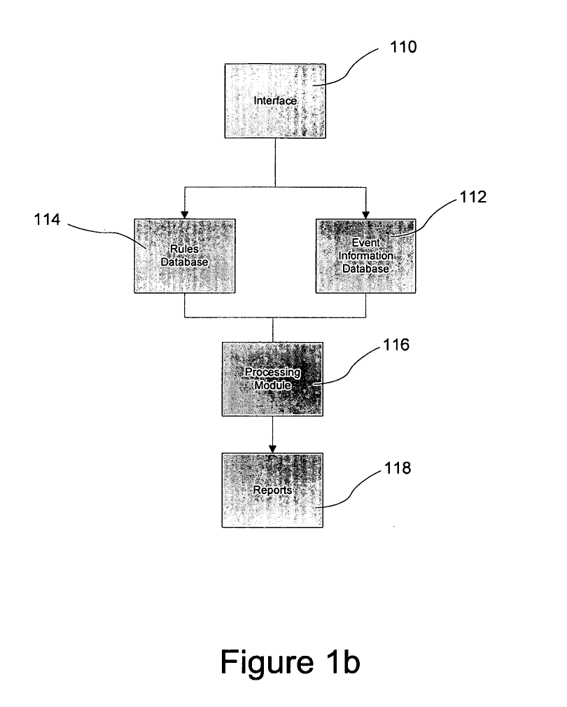

Referring to FIG. 1a, an exemplary computing system 100 on which the invention described herein can operate is shown. Typically, a plurality of computing devices are in communication with each other via a network system. In the exemplary embodiment, the computing locations are in communication with each other via the internet 110. However, other forms of networks could be used (e.g., local area networks (LANs), wide area networks (WANs), etc., whether wired or wireless). A server 102 typically resides within network 100. The server 102 can act as host for the software used to implement the methods in accordance with the present invention. The system can be accessed by a user 103, such as a salesperson who initiates an event. Access to the system can be accomplished, for example, by using an interface, such as a graphical user interface (GUI) on a computing device 105, to access a network based program or a web portal, for example. The system of the invention can also be accessed via various other computing devices 104, 106 that are in communication with the network (e.g., internet). This can allow access to the system by other users, such as various parties that are involved with the event coordination (e.g., venues, vendors, presenters, etc.).

Referring to FIG. 1b, an exemplary computing system in accordance with the invention described herein is shown. In the exemplary system, an interface (110) can be used to enter information of an event. The interface can be a user interface, such as a graphical user interface (GUI); or it can be a computer interface, such as can be used to input historical event information. Event information is entered and stored in an event information database (112). In addition, the same or another interface can be used to enter rules into a rules database (114). Processing module (116), operatively associated with both the event information database and the rules database, can use the rules to evaluate the event information, such as to determine event information compliance with applicable rules. If an event parameter or combination of parameters is not in compliance with one or more rules, or if the parameter is within a selected range or exceeds a selected threshold, the system can initiate one or more actions, such as disallowing a selection, displaying a message, sending an email to a compliance officer, etc. Processing module (116) can also analyze the event information, such as to determine variances between projected and actual costs of a single event, as hereinafter described, or to determine trends among a plurality of events. The processing module (116) can produce reports (118), such as can be used to document event compliance with the rules; prospective, actual, or historical event reports indicative of projected, actual, or past event activities, respectively; variance reports indicative of the variance between projected and actual event information, or indicative of the variance between two events, such as over time, or between different venues and/or regions; or trend reports indicative of trends among a plurality of events, such as trends over time, or trends between events in different regions, etc.

It is understood that, in addition to the specific embodiments described herein, the various techniques of the present invention may be implemented in hardware or software, or a combination of both. Software used may be implemented in various programming languages, including compiled or interpreted languages. Such software may be stored on a computer readable storage medium, where the storage medium is configured so as to cause a computer to perform the procedures described herein. The system can also be a distributed system, wherein various system functions are provided by different devices on the network.

The various exemplary embodiments hereinafter described can be implemented using a framework that allows for one or more of the following design considerations to be followed. The framework can allow for the creation of independent encapsulated modules that can be integrated into one application. It can allow for different application layers to be loosely coupled, and can provide the ability to integrate third party components, such as security components. The framework can allow for the ability to use validation rules. It can provide for the ability to show and hide data elements; and can allow for the ability to talk to and integrate external systems via well defined APIs. The framework can allow the ability to convert modules into independent stand alone systems with minimal effort. Module operation and interdependency can be configurable to the needs of a particular installation. The modules can be self contained so that changing the implementation of one module does not impact any of the other application modules.

Various user roles can be defined for a particular application context. Such user roles can include, for example, a meeting sponsor such as a sales representative; vendor; compliance officer; program administrator; etc. Selected functionality can be granted or restricted based on user roles. In this way, security management can be isolated for various services and roles, without affecting security for other services and roles.

A depository of rules for compliance checking, such as a rules database, is also provided. The rules can be laws, regulations, policies, or guidelines pertaining to events or to management of events. The rules can be self contained so that updating the rules does not impact the other application modules, and the updated rules can be used for compliance checking.

The user interface can be implemented graphically, such as via a web interface, and can be de-coupled from program functionality. Thereby, the interface can be customized for a particular installation, service, and/or role, with minimal impact on functionality.

### Automatic Event Planning & Compliance Application

In an exemplary embodiment, a system in accordance with the present invention can comprise several components. Each component is discussed herein with reference to a flowchart. It should be appreciated, however, that the system can operate with fewer than all of the components set forth herein, or with additional components added. Such variations would be apparent to one of skill in the art, and are encompassed within the spirit of the invention. Additionally, the exemplary embodiment described herein is described with reference to a pharmaceutical company. The invention, however, can be applicable to event planning in other fields or industries, for example, the financial planning industry.

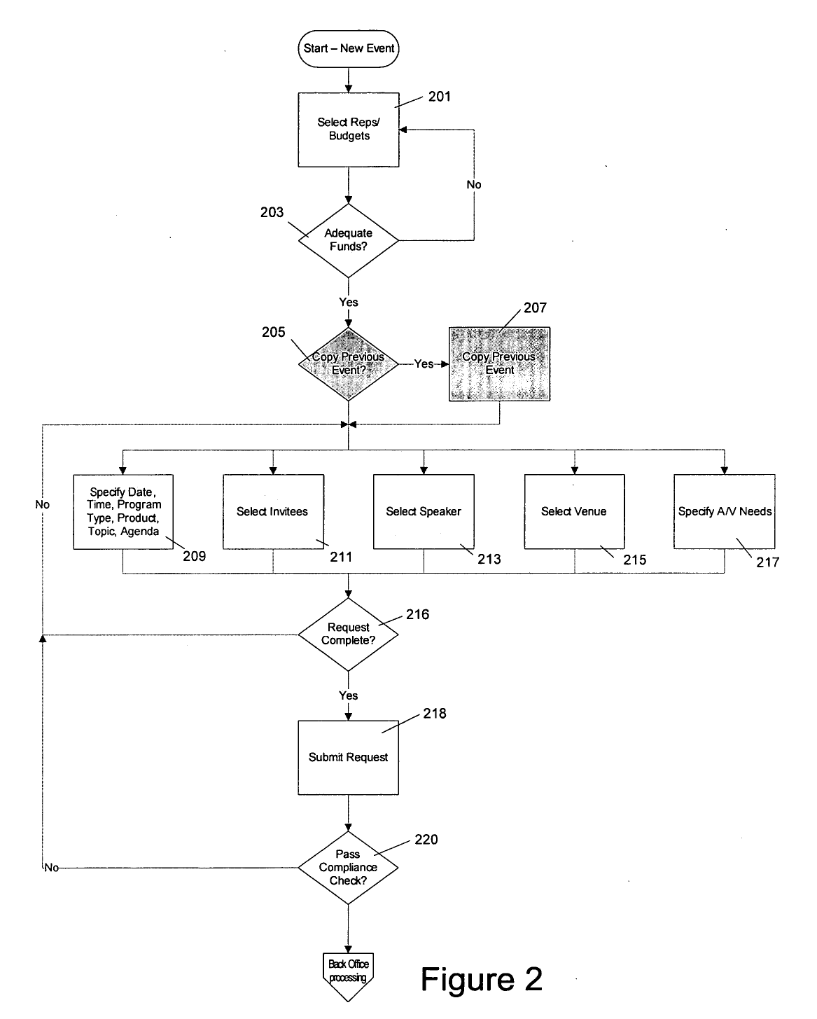

Referring to FIG. 2, a flowchart is shown illustrating the features provided in an exemplary embodiment of the present invention. In an exemplary scenario, a sales representative can use the system in order to plan a sales/marketing event. In the exemplary embodiment, such a sales representative, referred to herein as the “sponsor,” accesses the system and requests that an event be planned. This can involve identifying himself or herself to the system and requesting an event requiring a certain budgetary amount (step 201). The system can determine whether sufficient funds are available to process the request (step 203). This determination can be made by comparing the amount requested to the funds allocated from a predetermined budget. For example, each sponsor might have a particular amount of funds allocated to his or her budget. The system can check to assure the requested amount is within the amount available to the sponsor. If not, a message can be returned to the sponsor informing him or her that the requested event cannot be scheduled as requested. The system can also monitor requests for expenditures for compliance with specified policies and rules, and disallow requests for expenditures that are in violation of a policy or rule.

Information about a request can also be reported or made available to another user, such as a compliance officer. Such other user can be authorized to receive the report or to access information about a request. Such reporting can be of every requested event, or only of non-compliant events. The system can also be configured to not disallow a non-compliant event, and/or can be configured to flag it as non-compliant and allow the request to be accepted.

If the request is accepted, the system can proceed to the logistical planning of the event. In the exemplary embodiment, information regarding the event can be stored in an archive, and can be presented to a user, for example, to simplify requesting a subsequent event if the subsequent event is similar to a prior event, such as an event that is repeated several times. For example, a sponsor might have a particular expert present a talk on a particular product every six months at the same venue. After information regarding such an event is entered into the system, in order to subsequently facilitate processing of similar event requests, a determination can be made as to whether to copy information from another event (step 205). If so, the information from the other event can be retrieved from the archive file and used during the planning of the currently requested event (step 207). For example, if the request is for a repeat of a prior event, the prior event information can be made available to the sponsor, such as in response to the sponsor selecting an event from a list of previously entered events. The sponsor can then select some or all of the information of the other event, and can edit and modify the information as needed, subject to the parameters of the predetermined compliance rules. For example, compliance rules in the system can affect the ability of the sponsor to select attendees, such as by imposing a preset limit on the number of events an attendee can attend. If an attendee has already attended the preset limit of events allowed, or is otherwise disqualified, the system can disallow this attendee from being selected.

If the request is for a new event, several parameters can be specified by the sponsor. A series of menus can be presented to the sponsor to allow for simple selection of the various parameters, although other input forms can also be used. The sponsor can select the date and time desired for the event and indicates the type of program desired (e.g., lunch meeting, dinner, etc.). Additionally, the topic to be presented can be entered, and can include a product which is involved. A meeting agenda can also be specified at this point, if one has been created (step 209). Additionally, the sponsor can be reminded of applicable compliance rules, and/or can be prevented from entering parameters that are not in compliance with the predetermined rules (which can, for example, include corporate policies and/or state or federal laws and regulations).

If a request for a new event is contemplated by the user, and the user wants some guidance about the performance and effectiveness of different types of events, or optional parameters within an event given a desired outcome (e.g. the type of venue, the speaker selection, the program format, etc.), the system can allow for “what if” scenarios based on historical information. This can enable the establishment of best practices by the company.

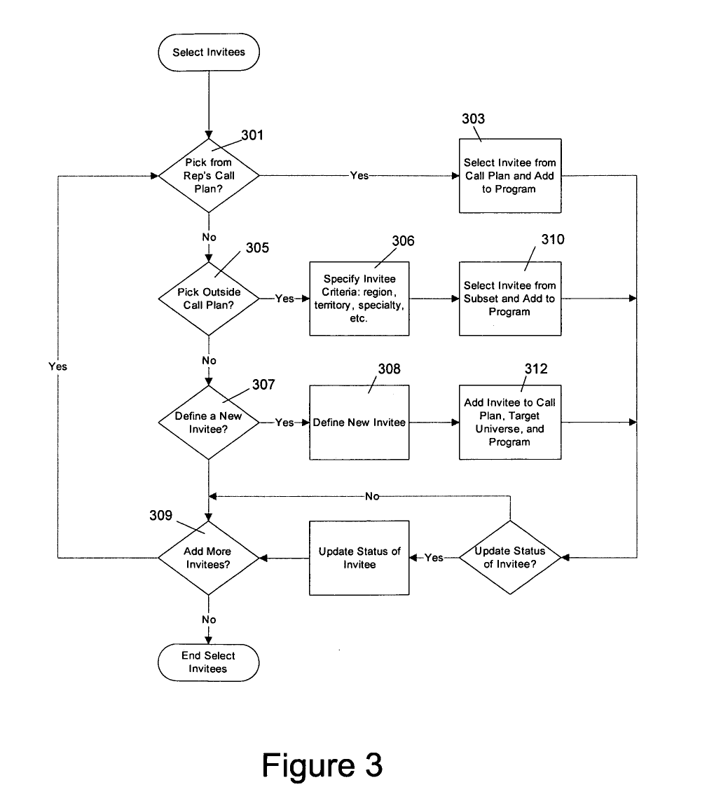

The sponsor can also select individuals and/or groups to be included as invitees (step 211). The selection of invitees is further illustrated in the flow chart of FIG. 3. In an exemplary embodiment, the sponsor has the option of choosing invitees from a previously generated and approved list (step 301). For example, doctors that the sponsor typically calls upon could be on the list, referred to as a call plan. After an invitee is chosen from the call plan, the corresponding information for the particular invitee can be added to the list of invitees for the program (step 303). The system can then inquire if there are additional invitees to be selected (step 309), and the process can be repeated until there are no further invitees to be added. Compliance rules in the system can affect the ability of sponsors to select attendees. For example, if an invitee has already attended the limit of the number of events he or she may attend, or is otherwise disqualified, the system can prevent his or her selection. An email can be generated automatically to remind sponsors to update invitee lists regularly. The frequency at which such email messages are sent can be set by predetermined rules stored in the system.

The sponsor need not be limited to choosing invitees only from a call plan. He or she can also choose from other invitees who are in the system (step 305). In the exemplary embodiment, when an invitee is selected who is not on the sponsor's call plan, the sponsor is prompted to input additional information (e.g., what territory the invitee resides in, what the specialty of an invitee is, etc.) (step 306). After entering the requested information regarding the invitee, the invitee can be added to the program (step 310). Additionally, the sponsor can add a new individual if a desired invitee is not currently in the system (step 307). In such cases, the sponsor can provide the information necessary to designate an invitee (e.g., name, contact information) (step 308). Once the invitee has been defined in the system, the invitee can be added to the program (step 312). The invitee can then be validated and approved in accordance with procedures established by the company.

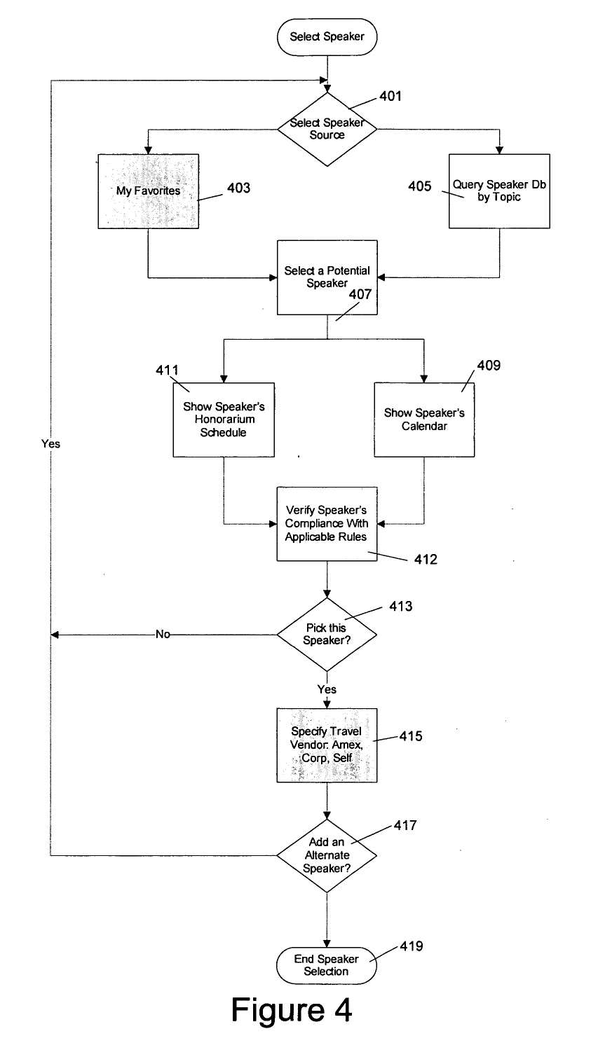

Referring again to FIG. 2, the sponsor can designate one or more desired speakers for the event (step 213). A speaker can be selected from a pre-qualified list of potential speakers. An example of the speaker selection process is illustrated in FIG. 4. In the exemplary embodiment, the sponsor can choose a source from which he or she wishes to select a speaker (step 401). For example, sources might include a database of speakers that have been identified as favored choices for the particular sponsor (e.g., a “my favorites” list) (step 403). Alternatively, the sponsor can request a topical listing of speakers contained in a database (step 405). From the chosen source, a potential speaker can be selected (step 407). Once a potential speaker is chosen, the system can return information regarding engagements for which the selected speaker has already been booked, such as in the form of a calendar (409). The speaker's approved topics and honorarium schedules can be accessed by the system (step 411). The system can assure that all applicable compliance rules are rigorously applied to usage of the speaker, for example, that speaker expenses are within the compliance rules, including laws and corporate policies, such as rules regarding fair market value of speaker remuneration and maximum annual payment amounts (step 412). After viewing the speaker's information, the sponsor can decide whether to select this speaker for the event or to return to the sources of speakers and select a different speaker (step 413). In an embodiment, the sponsor can be prevented from selecting a speaker that would cause a violation of any of the compliance rules (e.g., a speaker who has already presented the maximum number of times permitted).

Once a speaker has been selected, the system can facilitate arranging travel (step 415), such as by electronically communicating with other systems. Alternatively, the system can include a travel module that can arrange for booking and confirming travel needs (e.g., airline tickets, rental car, other ground transportation, etc.). For example, the client might have a preferred air travel booking engine, and in such cases, the system can include application programming interfaces (APIs) to allow for standardized communication with such engines.

The system can provide to the sponsor the ability to chose an alternate speaker (step 417). If the sponsor wishes to choose an alternate, the speaker choosing process can be repeated for the alternate speaker. Once speakers and alternates have been chosen, the speaker selection process is complete (step 419).

Referring again to FIG. 2, the system can also be configured to facilitate selecting an venue (step 215). In the exemplary system, a sponsor can specify parameters to select appropriate venues to invite to bid on the event. Such parameters can include factors such as geographic location (e.g., within 10 miles of Philadelphia, Pa.) and capacity (e.g., must have a room that can accommodate 50 people). Additionally, the sponsor can also identify the audio visual facilities desired for the presentation (step 217). For example, a particular presentation might require a projector system, speaker systems, displays, etc. The ability to accommodate the needs of the speaker can be an important element in selecting an appropriate venue or determining if an outside audio-visual vendor is desired. The needs of particular attendees can also be accommodated, such as providing special food menus, such as all Kosher or all vegetarian menus. Compliance rules can be set to prevent the selection of an unapproved vendor, or a venue that does not meet the requirements for the program (e.g., lack of a private room).

When the request is sufficiently specified by the sponsor (step 216), the request can be submitted to the system for processing (step 218). Before the request is processed, however, an additional compliance check can be performed (step 220). The compliance check can include checking various items to ensure the items meet with predetermined criteria, such as can be established by state and federal laws and regulations, and/or company policies. Examples of items that can be subjected to compliance checks are the amount paid to the speaker, the number of events an attendee has attended in a certain time period, the sufficiency of a venue's capacity, the cost of meals provided, restrictions on alcohol, cost of travel, scheduling times, speaker qualifications, etc. These criteria are by way of example only. The system can be configured to monitor preferred parameters for which compliance with rules or policies is desired.

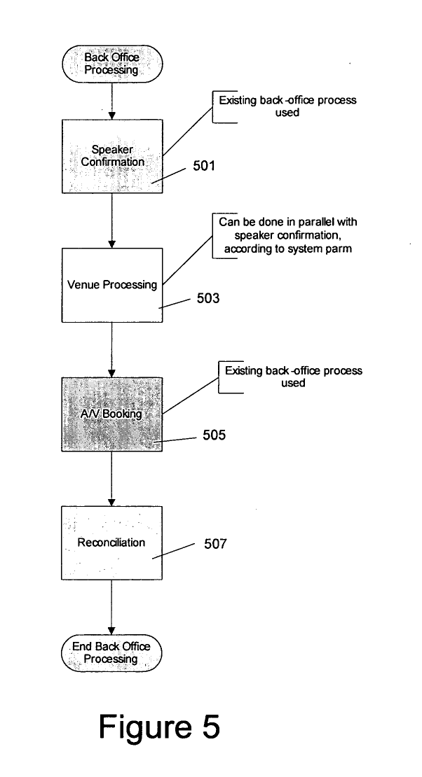

After successful completion of all compliance checks, the request can be submitted for processing. Request processing can include several phases, as shown in FIG. 5. A speaker confirmation process can be performed (step 501). A venue processing step can be performed to identify and book an appropriate venue (step 503). An audio visual (A/V) booking process can be performed to ensure an approved A/V vendor is selected and proper presentation equipment is available (step 505). Additionally, upon event completion, a complete reconciliation process can be performed (step 507). Each of these processes is described more fully below, and it is noted that the process steps are modular and can be managed in any order established by the client.

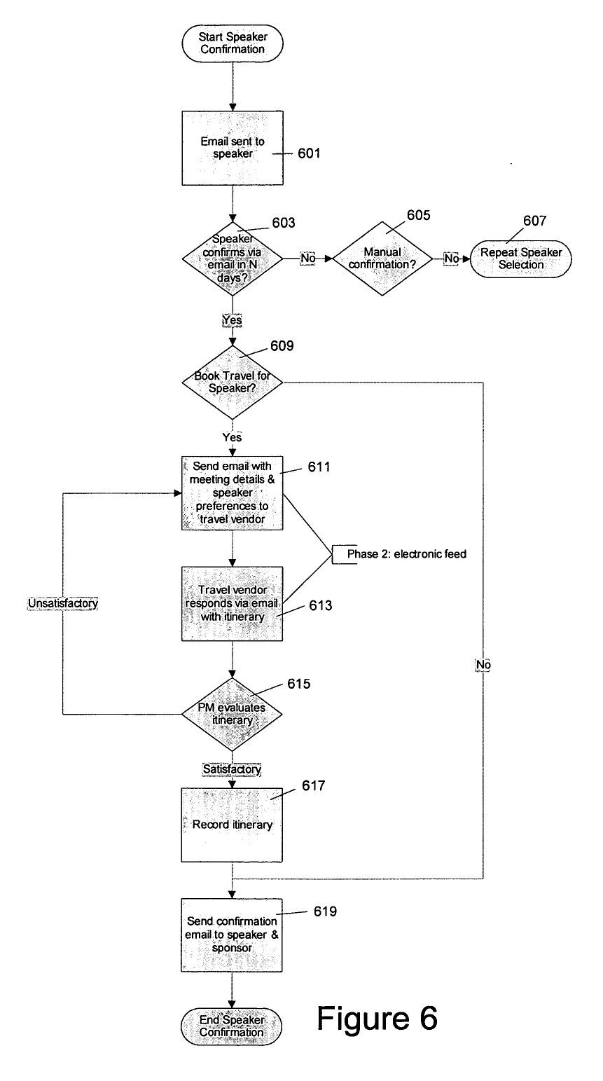

An exemplary speaker confirmation process is illustrated in FIG. 6. When the speaker confirmation process is initiated, a message can be sent to the prospective speaker, such as via email, although alternative methods (e.g., text message, voicemail message) could also be used (step 601). The speaker can be given a specified time for reply, for example, 3 days (step 603). If no confirmation is received, notification can be provided to the sponsor, or other designated individual, who can then perform a manual confirmation with the speaker (e.g., contact the speaker via letter, phone, or in person) (step 605). If the speaker declines, or cannot be confirmed, a new speaker can be selected and the process can be repeated (step 607).

If the speaker confirms his or her willingness to participate, a determination can be made as to whether the speaker will require travel arrangements (step 609). This can involve an evaluation of the speaker's geographic proximity to the area in which the event is to be held. Travel arrangements can be made at this point for speakers who require them. Several options can be used for travel arrangements, including electronic and/or manual methods. The entity that is used for arranging travel, whether automatically or manually, is referred to herein as the “travel module.” For example, if email is the chosen method for communication with the travel module, an email can be generated and sent to the travel module detailing the location and meeting specifics and any travel preferences of the speaker (611). The travel module can respond via email to the request (613). In an exemplary embodiment, the travel module can respond by completing an electronic form (eform) that is returned via email. The system can read the eform and automatically extract the travel itinerary. The itinerary can be evaluated (Step 615) by the traveler or their designee. If the itinerary is unacceptable, an additional request can be made to the travel module for a revised itinerary. If the itinerary is acceptable, it can be recorded into the system (step 617) and a confirmation can be sent to the speaker, and a copy can be provided to the sponsor as well (step 619). Compliance with travel policies can be monitored throughout this process. Such policies can vary depending upon the specific program and/or speaker.

In the exemplary implementation, in addition to confirming the speaker, the processing phase can include processing a venue for the program. This can be done in two phases. A request for proposal (RFP) can be generated and sent to selected venues. A particular venue can then be selected based upon the responses to the RFP received from the venues. The compliance and corporate policy rules govern whether a particular venue is available to be selected.

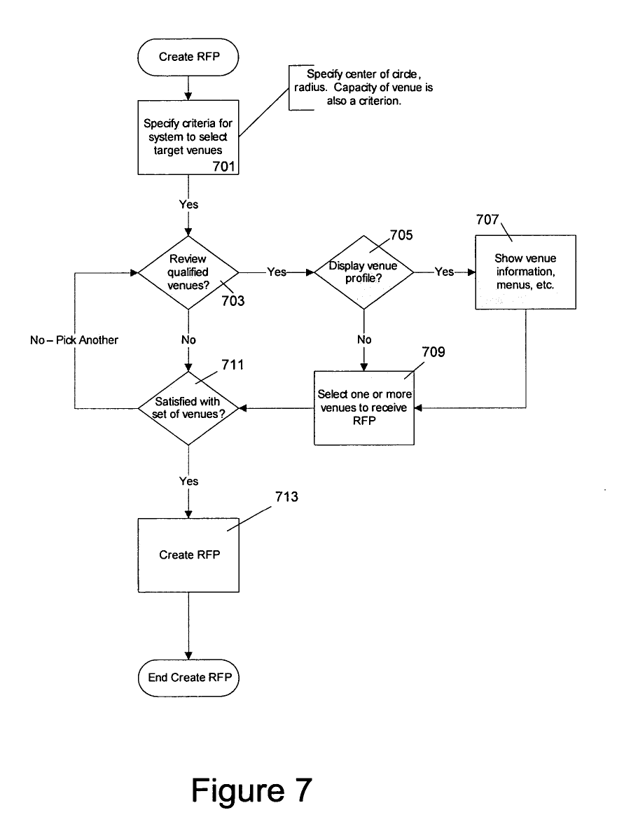

A flow chart illustrating an exemplary process for creating an RFP is shown in FIG. 7. The RFP can be populated with the desired criteria for the event, based upon the sponsor's specifications (step 701). The criteria can then be compared to potential venues and reviewed (step 703). For example, a profile from a particular venue can be displayed (step 705). The profile can include items such as the location of the venue, room availability, meal menus, parking availability, etc. (step 707). Based upon the qualifying criteria, the profiled venue can be selected to receive an RFP, or rejected as a potential venue (step 709). This process can be repeated until a preferred number of venues has been selected (step 711). The system can be configured based on corporate policies and business rules, for example, to send the RFP to a minimum number of venues (e.g., continue until 3 venues selected), or alternatively, to all venues meeting the selection criteria within a certain geographic area, such as within a selected radius of a specified location. Upon completing the selection of venues to receive the RFP, the final RFP can be created, such as by incorporating selection criteria on a form RFP addressed to each selected potential venue, as well as incorporating contracting language and/or requirements set out by the company (step 713).

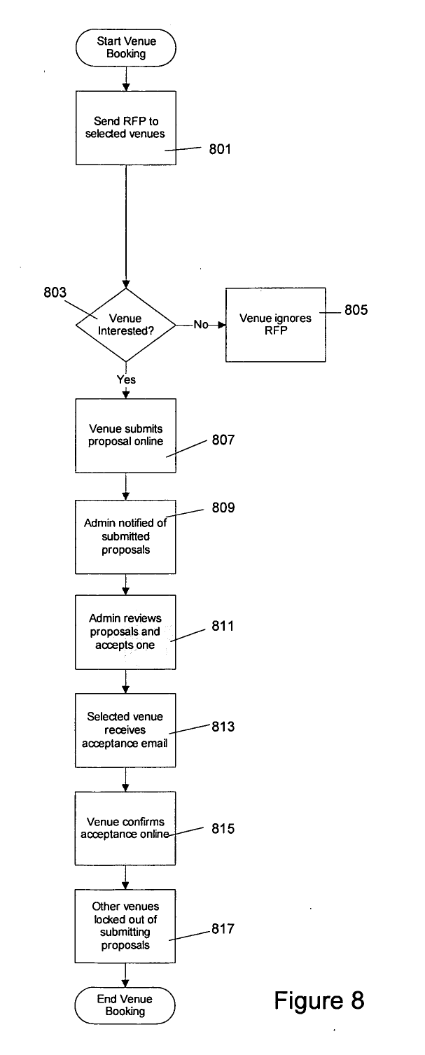

The steps involved in an exemplary process for using the generated RFP to book a venue are illustrated in FIG. 8. The RFP can be sent to the selected venues, such as via email (step 801). The RFP can be reviewed by each venue to determine if the venue has an interest in hosting the event (step 803). The RFP can indicate that no response is to be sent if the venue is not interested. Thus, if the venue ignores the RFP, the venue is not considered for the event (step 805). If the venue is interested, the venue can submit a proposal, such as via email. Alternatively, a web portal can be used to allow venues to log onto the system and submit detailed proposals (step 807). In addition, menu items as well as compiled menus can be stored by the venue for easy selection and/or modification. Such menus can be pre-negotiated in compliance with applicable company rules or policies.

When a proposal is submitted to the online portal, the proposal can be stored. An email notification can be sent to an administrator to inform him or her of the availability of proposals (step 809). The system can automatically perform an analysis of various factors (e.g., a decision tree analysis) using preset rules and procedures to select a preferred venue. Alternatively, an administrator can review the proposals or a summary of the proposals, and select the preferred venue (step 811) according to company policies and business rules established by the company (e.g., lowest bid, earliest bid received, etc.). The selected venue can be notified, such as via email, that it has been chosen (step 813). The venue can confirm acceptance, such as via the online portal (step 815). Once a venue has confirmed, the system can automatically lock out any remaining venues from submitting proposals (step 817). The contracting language with the venue can then be confirmed and the venue can be provided with a form of payment to hold the reservation (e.g., a credit card number).

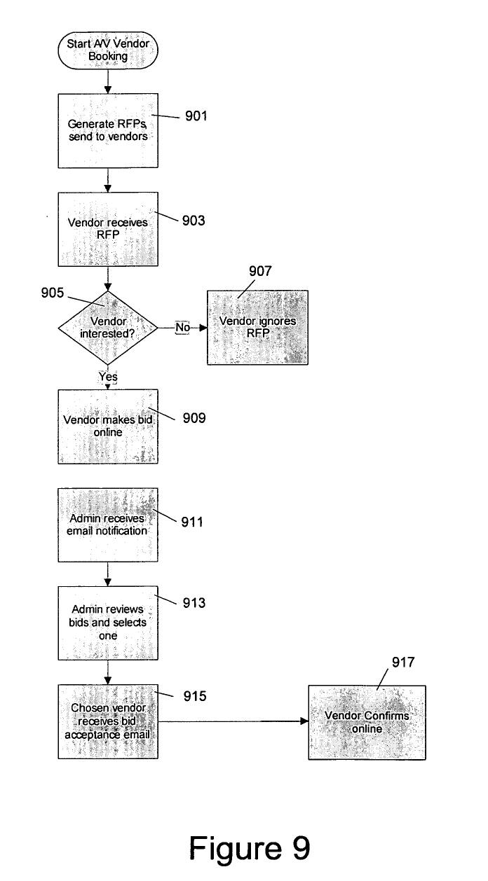

In addition to booking a venue, the processing of the sponsor's request for an event can include booking an audio-visual (AV) vendor. While some venues might provide A/V services, a separate entity is often contracted to handle this aspect, particularly for events with complex requirements. The steps involved in an exemplary process for booking an A/V vendor are illustrated in FIG. 9. An RFP can be generated in a similar fashion as described above with reference to venues (step 901). The RFP can specify the requirements of the event, based for example upon the initial criteria provided by the sponsor. The RFP can be sent to one or more vendors, such as via email (step 903). The RFP can be reviewed by the vendor to determine if there is an interest in providing services for the event (step 905). The RFP can indicate that no response is to be sent if the vendor is not interested. Thus, if the vendor ignores the RFP, the vendor is not considered for the event (step 907). If the vendor is interested, a proposal can be submitted, such as via email, or a web portal can be used to allow vendors to log onto the system and submit detailed proposals (step 909).

When a proposal is submitted via the online portal, the proposal can be stored and an administrator or the sponsor can be notified, such as via email. The system can automatically perform an analysis of the various factors (e.g., a decision tree analysis) using preset rules and procedures to select a vendor, or alternatively, an administrator can review the proposals or a summary of the proposals and select a preferred vendor (steps 911, 913). The selected vendor can be notified, such as via email, that it has been chosen (step 915). The vendor can confirm acceptance, such as via the online portal (step 917). Contracting language can be provided by the system.

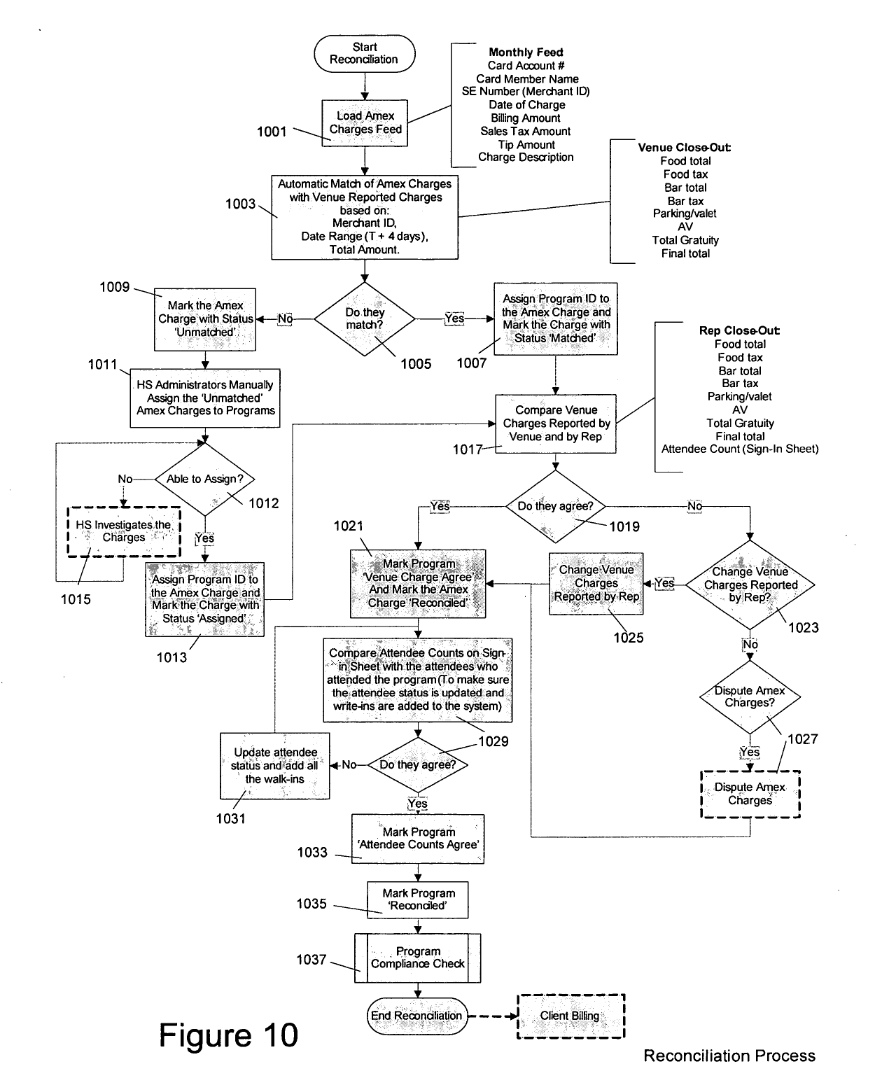

In the exemplary embodiment, the final processing steps can occur following the event. Following the event, system users such as the sponsor, the venue, and the speaker can all be reminded, such as via email, to enter closing information into the system. A reconciliation can be performed to ensure that the event transpired as expected and was completed in accordance with applicable compliance rules. The steps involved in an exemplary reconciliation are shown in FIG. 10. A payment method and billing rate can be predetermined for the venue. In the exemplary embodiment, an American Express (Amex) credit card vehicle is used. The system can interface directly by way of APIs, or indirectly by way of uploads, with the Amex system to load the charges entered for the event (step 1001). By identifying various parameters that fall within predetermined tolerances, the charges for a particular event can be distinguished from other charges (step 1003). Such parameters can include the merchant identification code, the amount of the charge, and the date of the charge. A comparison can be made between the charges obtained directly from Amex, and expected charges as reported from the venue. If the charges match within a set tolerance range (step 1005), each charge can be assigned to the particular program via an identification code and marked as a match (step 1007). If any of the expected charges do not match within an established tolerance range, the charge in question can be marked as “unmatched” (step 1009) and forwarded to an administrator for potential manual matching (step 1011). If the charge can be assigned manually (e.g., a number was mis-keyed and the correction can be made) (step 1012), the charge can be marked “assigned” (step 1013). If this is not possible, the administrator can investigate the charge to determine the error (step 1015).

Once the charges are matched or assigned, each charge can be compared against a close-out report submitted by the sponsor. At the conclusion of each event, the sponsor can use the system to submit information regarding the event in a close-out report. For example, the close-out report can include the final attendance count, final cost, and an explanation of any variance between the final numbers and the expected numbers. Items used in compliance checks, such as receipts and signatures of attendees, can also be submitted, such as electronically (e.g., scanned from a paper or fax submission). Attendees can be confirmed by any appropriate identity confirmation means, such as by photo ID or signature verification. Evaluation forms can be completed to evaluate the speaker and the overall program. The charges submitted by the venue and matched to the Amex charges can be compared to the information from the close-out report (step 1017).

If the charges match within a set tolerance range (step 1019), an indication can be made that the charges from the venue agree and the Amex report can be marked as reconciled (step 1021). However, if the charges do not match within the set tolerance range, the charges can be examined to see if an error was made by the sponsor (step 1023). If so, the charges can be edited (step 1025). If no error is detected, the charges can be disputed with Amex (step 1027).

A comparison can also be made to verify that the number of attendees reported by the sponsor corresponds with an attendee sign-in sheet, such as would be completed at the event (step 1029). If they do not match, the attendee count can be updated to include any “walk-ins” (e.g., attendees who attended unexpectedly and thus were not on the pre-printed sign-in sheet) (step 1031). If the attendee counts match, the program can be marked accordingly (step 1033). At this point, the program can be marked as reconciled (step 1035) and the system can proceed to the compliance verification (step 1037). Signatures of the attendees can be stored electronically, such as for future auditing needs.

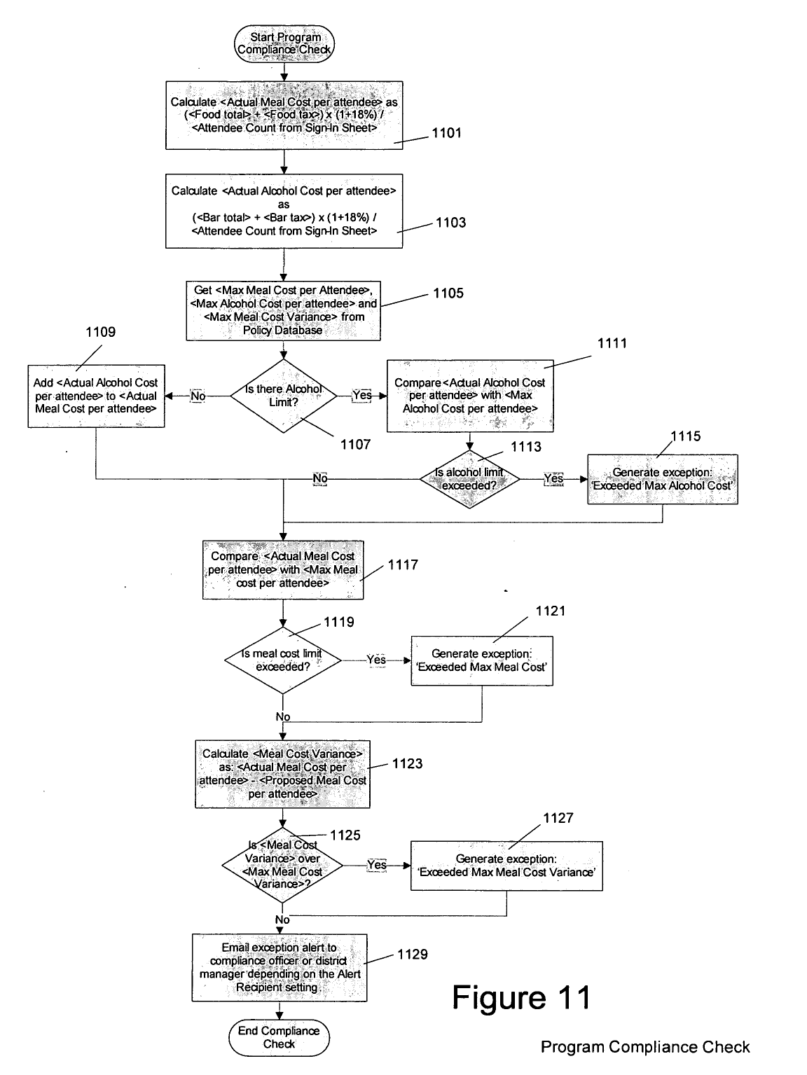

Compliance monitoring can be applied to any stage of the event planning, booking, or processing. For example, an exemplary compliance monitoring process that is used to monitor whether the food services provided are within a set of predetermined rules is illustrated in FIG. 11. The cost of the meal provided (per attendee) can be calculated by dividing the total costs (including taxes and gratuities) by the total number of attendees (step 1101). In addition, any alcohol expenses can be similarly calculated (step 1103). The maximum allowed costs for these items can be retrieved from a policy database which stores predetermined rules for compliance (step 1105). These rules can be used to determine if the program was in compliance. For example, a determination can be made from the retrieved information as to whether a limit was to be imposed on the alcohol (step 1107). If the rules do not indicate that alcohol should be evaluated separately, the alcohol cost can be added to the overall meal cost (step 1109). If, however, a limit on the expenditures for alcohol was to be imposed, a comparison can be made comparing the actual cost for alcohol with the maximum allowable cost (step 1111). A determination can be made from this comparison as to whether the predetermined limit was exceeded (step 1113). If so, an exception message can be generated for reporting (step 1115).

The cost of the meal can be similarly compared with the predetermined limit (step 1117). A determination can be made from this comparison whether the predetermined limit was exceeded for the meal (step 1119). If so, an exception message can be generated for reporting (step 1121).

Additionally, the variation of the actual cost of the meal from the budgeted meal cost can be calculated by subtracting the actual cost from the budgeted cost (step 1123). The result can be compared with a predetermined limit. Often, this is desired to determine if the money budgeted was appropriate. A determination can be made from this comparison whether the predetermined limit for variance was exceeded for the meal (step 1125). If so, an exception message can be generated for reporting (step 1127).

The generated exceptions can be compiled into a report, and/or presented graphically, for example, via a reporting dashboard (step 1129). Graphical presentation can provide information regarding the various algorithmic treatments used for decision support. Such reports and/or graphical presentations can provide a compliance officer for the company (or a district manager or another designated recipient, depending upon the configuration of the system), with important data regarding not only the activities performed, but also other information that can be obtained using the data. For example, a report compiling the actual usage of minority owned vendors can lead to adjusting the usage of certain vendors for the remainder of a year in order to achieve certain goals, such as regarding diversity. The reports can be provided via specially designed portals configured to aid in decision support and analysis for a particular user's area of expertise.

Event planning has typically been an involved process, which traditionally caused companies to expend significant resources, either in manpower to handle the tasks or in expenditures to outsource the task. Additionally, because of the complexity of the tasks and the complexity of the rules governing these events, monitoring compliance with rules and regulations, both external (such as government regulations and laws) and internal (such as company policies) has traditionally been a difficult, if not impossible, task. The present invention allows for full and complete monitoring of event-related activities to ensure compliance with these rules and regulations, and enables companies to improve the management of their activities in accordance with them.

Although exemplary embodiments of the invention have been described in detail herein, a variety of modifications to the embodiments described herein will be apparent to those skilled in the art. Thus, the present invention may be embodied in other specific forms without departing from the spirit or essential attributes thereof and, accordingly, reference should be made to the appended claims, rather than to the foregoing specification, as indicating the scope of the invention.

What is claimed is:

1. A method of using a computer system for event management and ensuring compliance with rules pertaining to an event, the method comprising:
providing in the computer system a rules database containing rules pertaining to the event;
specifying parameters of the event using the computer system; and
ensuring by the computer system that the event parameters conform to the rules.

2. The method of claim 1, wherein the rules include at least one of:
one or more laws;
one or more regulations; and
one or more policies.

3. The method of claim 1, further comprising initiating the event using the computer system.

4. The method of claim 1, wherein the step of specifying event parameters comprises at least one of:
specifying at least one of event date, time, program type, topic, and agenda;
selecting at least one invitee;
selecting at least one speaker;
selecting at least one venue; and
specifying audio/visual equipment.

5. The method of claim 1, further comprising:
updating one or more rules in the rules database; and
ensuring by the computer system that the event parameters conform to the updated rules.

6. The method of claim 1, further comprising:
determining by the computer system projected event information based on the event parameters;
holding the event;
inputting actual event information into the computer system; and
reconciling by the computer system the actual event information with the projected event information.

7. The method of claim 6, wherein at least one of the determining projected event information step and the reconciling step also uses information of other events.

8. The method of claim 6, wherein:
the projected event information includes at least one of projected number of attendees, projected food cost per attendee, projected bar cost per attendee, projected venue charges, projected food total, projected food tax, projected bar total, projected bar tax, projected parking costs, projected audio-visual equipment costs, projected gratuity, and projected total cost of the event; and
the actual event information includes at least one of actual number of attendees, actual food cost per attendee, actual bar cost per attendee, actual venue charges, actual food total, actual food tax, actual bar total, actual bar tax, actual parking costs, actual audio-visual equipment costs, actual gratuity, and actual total cost of the event.

9. The method of claim 6, further comprising:
generating at least one of:
one or more prospective event reports indicative of projected event activities prior to completion of the event activities;
one or more actual event reports indicative of actual event activities following completion of the event activities; and
one or more variance reports indicative of the variance between projected event information and actual event information.

10. A computer readable medium having computer readable instructions to instruct a computer to perform a method for event management and ensuring compliance with applicable rules, the method comprising:
receiving parameters of a prospective event;
evaluating the event parameters using rules in a rules database; and
initiating at least one action based on the evaluation, to restrict a user action or notify a user of an evaluation result.

11. The computer readable medium of claim 10, wherein:
the evaluating step comprises determining if an event parameter or combination of parameters is at least one of:
not in compliance with one or more rules;
exceeds a selected threshold; and
within a selected range; and
the action in the initiating step comprises at least one of:
disallowing the selection of at least one event parameter;
displaying at least one message; and
sending at least one email.

12. The computer readable medium of claim 10, wherein the rules include at least one of:
one or more laws;
one or more regulations; and
one or more policies.

13. The computer readable medium of claim 10, wherein the method further comprises:
determining projected event information based on the event parameters;
receiving actual event information; and
reconciling the actual event information with the projected event information.

14. A computer system for event management and ensuring compliance with rules pertaining to an event, the system comprising:
a rules database containing rules pertaining to the event;
a user interface (UI) for specifying parameters of the event;
an event information database operatively associated with the UI for storing the event parameters; and
a processing module operatively associated with the rules database and the event information database for ensuring that the event parameters conform to the rules.

15. The computer system of claim 14, wherein the rules include at least one of:
one or more laws;
one or more regulations; and
one or more policies.

16. The computer system of claim 14, wherein the user interface is a graphical user interface (GUI).

17. The computer system of claim 14, wherein:
the processing module generates projected event information based on the event parameters;
the UI is used to input actual event information; and
the processing module reconciles the actual event information with the projected event information.

18. The computer system of claim 17, wherein:
the event information database stores historical event information; and
the processing module uses the historical event information for at least one of generating the projected event information and reconciling the actual event information and the projected event information.

19. The computer system of claim 17, wherein:
the projected event information includes at least one of projected number of attendees, projected food cost per attendee, projected bar cost per attendee, projected venue charges, projected food total, projected food tax, projected bar total, projected bar tax, projected parking costs, projected audio-visual equipment costs, projected gratuity, and projected total cost of the event; and
the actual event information includes at least one of actual number of attendees, actual food cost per attendee, actual bar cost per attendee, actual venue charges, actual food total, actual food tax, actual bar total, actual bar tax, actual parking costs, actual audio-visual equipment costs, actual gratuity, and actual total cost of the event.

20. The computer system of claim 14, wherein the event parameters comprise at least one of:
one or more of event date, time, program type, topic, and agenda;
information of at least one invitee;
information of at least one speaker;
information of at least one venue; and
information of audio/visual equipment.

21. The computer system of claim 17, wherein:
the processing module is for generating at least one of:
one or more prospective event reports indicative of projected event activities prior to completion of the event activities;
one or more actual event reports indicative of actual event activities following completion of the event activities; and
one or more variance reports indicative of the variance between projected event information and actual event information.

22. A method of using a computer system for historical event evaluation comprising:
providing in the computer system a rules database containing rules pertaining to events;
entering historical event information using the computer system; and
evaluating by the computer system the historical event information using the rules.

23. The method of claim 22, wherein the rules include at least one of:
one or more laws;
one or more regulations; and
one or more policies.

24. The method of claim 22 further comprising using the evaluated historical information to make recommendations for managing events.

25. The method of claim 22 further comprising analyzing by the computer system the historical event information.

26. The method of claim 25 further comprising using at least one of the evaluated and the analyzed historical information to make recommendations for managing events.

27. The method of claim 22, wherein:
the historical event information includes for one or more past events information of:
at least one of attendees, food cost, bar cost, venue charges, taxes, parking cost, audio-visual equipment cost, gratuity, and total event cost.

28. A computer readable medium having computer readable instructions to instruct a computer to perform a method for historical event evaluation, the method comprising:
receiving historical event information;
evaluating the historical event information using rules provided in a rules database; and
reporting the evaluation results.

29. The computer readable medium of claim 28, wherein the rules include at least one of:
one or more laws;
one or more regulations; and
one or more policies.

30. The computer readable medium of claim 28, wherein the method further comprises:
updating one or more rules in the rules database; and
evaluating the historical event information using the updated rules.

31. The computer readable medium of claim 28, wherein the method further comprises using the evaluated historical information to make recommendations for managing events.

32. The computer readable medium of claim 28, wherein the method further comprises analyzing the historical event information.

33. The computer readable medium of claim 32, wherein the method further comprises using at least one of the evaluated and the analyzed historical information to make recommendations for managing events.

34. The computer readable medium of claim 28, wherein:
the historical event information includes for one or more past events information of:
at least one of attendees, food cost, bar cost, venue charges, taxes, parking cost, audio-visual equipment cost, gratuity, and total event cost.

35. A computer system for historical event evaluation comprising:
a rules database containing rules pertaining to events;
an interface for inputting historical event information;
an event information database operatively associated with the interface for storing the historical event information; and
a processing module operatively associated with the rules database and the event information database for evaluating the historical event information using the rules.

36. The computer system of claim 35, wherein the rules include at lease one of:
one or more laws;
one or more regulations; and
one or more policies.

37. The computer system of claim 35, wherein the processing module uses the evaluated historical event information to make recommendations for managing events.

38. The computer system of claim 35, wherein the processing module analyzes the historical event information.

39. The computer system of claim 38, wherein the processing module uses at least one of the evaluated and the analyzed historical information to make recommendations for managing events.

40. The computer system of claim 35, wherein the historical event information includes for one or more past events information of:
at least one of attendees, food cost, bar cost, venue charges, taxes, parking cost, audio-visual equipment cost, gratuity, and total event cost.
